(19) United States
(12) Patent Application Publication
(10) Pub. No.: US 2025/0075348 A1
(43) Pub. Date: Mar. 6, 2025

(54) Electrolytic Cell Stack

(71) Applicant: Parker-Hannifin Corporation, Cleveland, OH (US)

(72) Inventor: Linh T. Pham, Chula Vista, CA (US)

(21) Appl. No.: 18/638,816

(22) Filed: Apr. 18, 2024

Related U.S. Application Data
(60) Provisional application No. 63/579,162, filed on Aug. 28, 2023.

(51) Int. Cl. C25B 11/03; C25B 9/70; C25B 13/02

(52) U.S. Cl. CPC C25B 11/03; C25B 13/02; C25B 9/70

(57) ABSTRACT

An example cell stack assembly includes: a plurality of electrode plates having: (i) respective terminal tabs integrated therewith for providing electric power to the plurality of electrode plates, (ii) and respective ports; and a plurality of separator plates interleaved with the plurality of electrode plates and having respective ports aligned with the respective ports of the plurality of electrode plates to form channels that allow electrolyte flow therethrough, wherein the plurality of electrode plates have locating and orientation features, and wherein the plurality of separator plates have corresponding locating and orientation features that facilitate mounting the plurality of electrode plates to the plurality of separator plates in a unique order and orientation.

### CROSS REFERENCE TO RELATED APPLICATION

The present application claims priority to U.S. Provisional Application No. 63/579,162 filed on Aug. 28, 2023, the entire contents of which are herein incorporated by reference as if fully set forth in this description.

### BACKGROUND

Electrolytic cell stacks are used in many applications such as battery and electrolysis applications to separate elements or produce certain chemicals from electrolytes. These applications require complicated and often ineffective sealing and containment of electrolyte fluids inside cavities of the cell stack.

Further, such cell stacks typically include multiple plates that have to be oriented in a particular way for the cell stack to operate properly. If the plates are assembled in the wrong orientation, the cell stack would not work properly.

Further, electric current is introduced into electrode plates to create a potential between the plates. In conventional cell stacks, current is introduced to the plates via complex components (e.g., rods with multiple seals) that in some cases are welded to the plates. Such complex components reduce reliability and increase the likelihood of failure as cracks might occur and seals might fail. They also increase cost.

It may thus be desirable to have a cell stack that allows the assembly of plates in only one orientation and order to avoid wrong assembly of the components, allows electric power to be introduced in a reliable, cost effective manner, and provides effective sealing of various channels and cavities in the cell stack. It is with respect to these and other considerations that the disclosure made herein is presented.

### SUMMARY

The present disclosure describes implementations that relate to an electrolytic cell stack.

In a first example implementation, this disclosure describes a cell stack assembly including: a plurality of electrode plates having: (i) respective terminal tabs integrated therewith for providing electric power to the plurality of electrode plates, (ii) and respective ports; and a plurality of separator plates interleaved with the plurality of electrode plates and having respective ports aligned with the respective ports of the plurality of electrode plates to form channels that allow electrolyte flow therethrough, wherein the plurality of electrode plates have locating and orientation features, and wherein the plurality of separator plates have corresponding locating and orientation features that facilitate mounting the plurality of electrode plates to the plurality of separator plates in a unique order and orientation.

In a second example implementation, this disclosure describes a method of assembling the cell stack assembly of the first example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a perspective view of a cell stack assembly, according to an example implementation.

FIG. 2 illustrates a perspective exploded view of the cell stack assembly of FIG. 1, according to an example implementation.

FIG. 3 illustrates a partial exploded view of the cell stack assembly of FIGS. 1-2, according to an example implementation.

FIG. 4 illustrates a perspective view of a separator plate depicting a front side thereof, according to an example implementation.

FIG. 5 illustrates a cross sectional view of the separator plate of FIG. 4, according to an example implementation.

FIG. 6 illustrates another perspective view of the separator plate of FIG. 4 depicting a back side thereof, according to an example implementation.

FIG. 7 is a flowchart of a method of assembling a cell stack assembly, in accordance with an example implementation.

FIG. 8 is a flowchart of additional operations performed with the method of FIG. 7, in accordance with an example implementation.

### DETAILED DESCRIPTION

Disclosed herein is a cell stack with a locating pin and locating hole pattern on plates (e.g., electrodes and separator plates) that facilitate assembling the cell stack in a unique order and orientation (e.g., in a poka-yoke or mistake-proof manner). The separator plates have a seal and groove configuration that forms flow channels and eliminate the need for additional flow ducting.

Many chemistry and manufacturing applications involve the process of electrolysis, which is a technique that uses direct electric current (DC) to drive an otherwise non-spontaneous chemical reaction to separate elements of an electrolyte using an electrolytic cell. An electrolyte can be a medium containing ions that is electrically conducting through the movement of those ions, but not conducting electrons. Example electrolytes include soluble salts, acids, and bases dissolved in a polar solvent, such as water, etc. Upon dissolving, the substance separates into cations and anions, which disperse uniformly throughout the solvent. In medicine and sometimes in chemistry, the term electrolyte refers to the substance that is dissolved

The voltage that is needed for electrolysis to occur can be referred to as the decomposition potential. Thus, electrolysis involves breaking down the electrolyte into separate elements (e.g., separate fluids) when subjected to the electric power/current with at least the decomposition potential. In practice, electrolysis involves using an electrolytic cell stack assembly that includes one or more cell stacks assembled together.

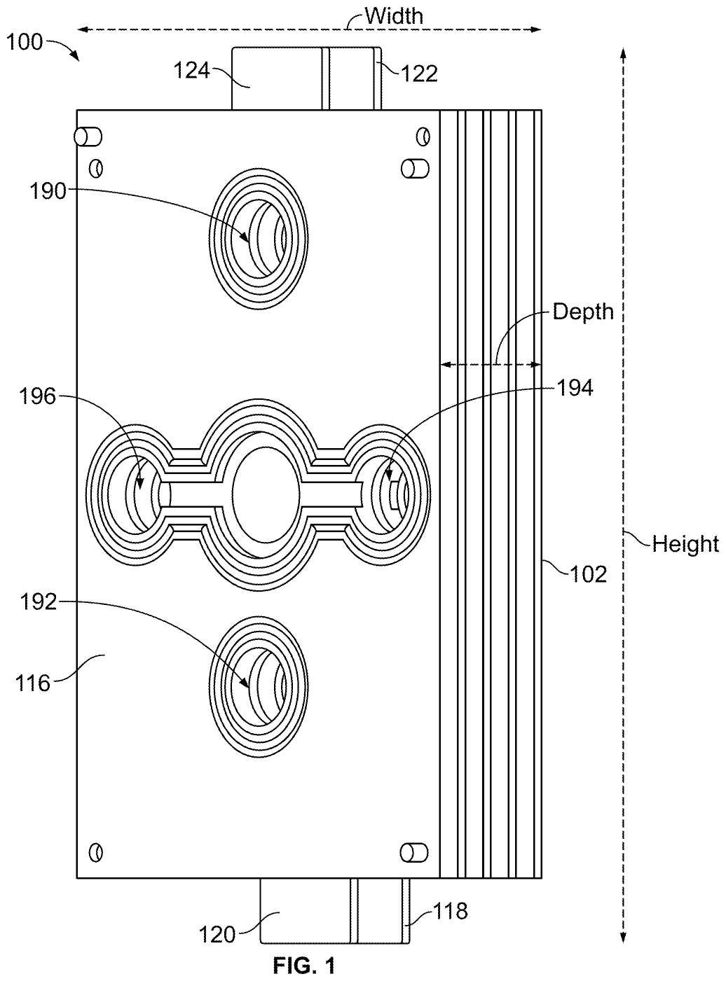

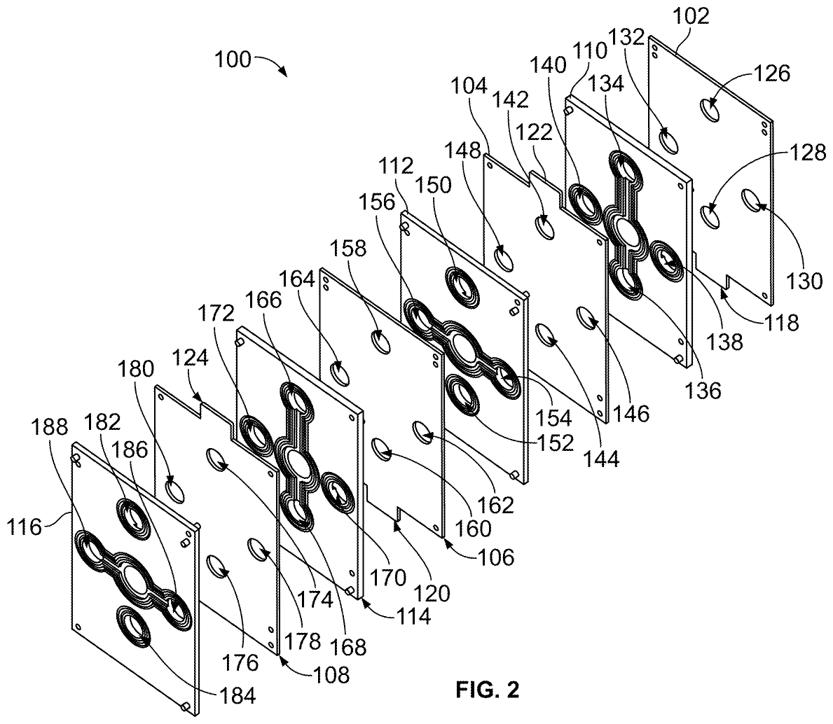

FIG. 1 illustrates a perspective view of a cell stack assembly 100, and FIG. 2 illustrates a perspective exploded view of the cell stack assembly 100, according to an example implementation. The cell stack assembly 100 includes a plurality of electrode plates interleaved with a plurality of separator plates such that each separator plate is interposed between two electrode plates, and the separator plate electrically insulates the electrode plates from each other. For example, referring to FIG. 2, the cell stack assembly 100 includes a first electrode plate 102, a second electrode plate 104, a third electrode plate 106, and a fourth electrode plate 108. The electrode plates 102-108 are made of an electrically-conductive material (e.g., metallic material).

The cell stack assembly 100 also includes a first separator plate 110, a second separator plate 112, a third separator plate 114, and a fourth separator plate 116 that are interposed between respective electrode plates of the electrode plates 102-108. The separator plates 110-116 are made of an electrically-insulating material (e.g., thermoplastic material). Each of the electrode plates 102-108 and the separator plates 110-116 is generally formed as a rectangular prism having a width, length (or depth), and height.

The number of electrode plates and separator plates shown in FIGS. 1-2 is an example for illustration. More or fewer electrode plates and separator plates can be used as desired.

A subset of the electrode plates 102-108 are configured as cathode (e.g., electric negative terminal) plates and the remaining plates of the electrode plates 102-108 are configured as anode (e.g., electric positive terminal) plates. For example, in FIG. 2, the electrode plate 102 has a terminal tab 118 integrated therewith and the electrode plate 106 has a terminal tab 120 integrated therewith. The electrode plates 102, 106 can be configured as cathode plates, for example, and their terminal tabs 118, 120 can thus be connected to a negative terminal of a source of electric power (e.g., a battery).

In this example, the electrode plate 104 has a terminal tab 122 integrated therewith and the electrode plate 108 has a terminal tab 124 integrated therewith. The electrode plates 104, 108 can be configured as anode plates, for example, and their terminal tabs 122, 124 can thus be connected to a positive terminal of the source of electric power.

Notably, the terminal tabs 118-124 are integrated into their respective electrode plates 102-108, respectively. This configuration may provide an advantage over conventional cell stacks. Particularly, conventional cell stacks typically use a rod that is introduced into the cell stack and is welded or otherwise coupled to a respective electrode. Seals and other components are mounted to the rod. Such rod and associated components add to the cost of the cell stack and reduces its reliability. As such, the configuration of the cell stack assembly 100 may reduce complexity and cost as the electric power is introduced into the cell stack assembly 100 via the terminal tabs 118-124, which are integrated into the respective electrode plates. No other separate components are coupled to the electrode plates to introduce electric power.

Further, as depicted, the terminal tabs 118, 120 of the electrode plates 102, 106 (e.g., the cathode plates) are disposed or point in a first direction (downward), while the terminal tabs 122, 124 of the electrode plates 104, 108 (e.g., the anode plates) are disposed or point in a second direction (upward), opposite the first direction. The terminal tabs pointing in different directions distinguish the cathode plates from the anode plates, and is one of the features that facilitate assembling plates of the cell stack assembly 100 in only one unique order and orientation such that the assembly is mistake-proof as described in more details below. However, it should be understood that the way the terminal tabs 118-124 point can be changed. For example, the terminal tabs can point in opposite sideways directions (e.g., laterally) rather than upward/downward (longitudinally).

Further, the electrode plates 102-108 and the separator plates 110-116 have respective ports (e.g., through-holes, openings, or windows) that are aligned when assembled to form ducts or channels for electrolyte flow. For example, as depicted in FIGS. 1-2, each of the electrode plates 102-108 and the separator plates 110-116 has four ports, two ports disposed longitudinally (e.g., near top end and near bottom end), while the remaining two ports are disposed laterally (near first side end and near second side end).

Particularly, as shown in FIG. 2, the electrode plate 102 has a first port 126, a second port 128, a third port 130, and a fourth port 132. The separator plate 110 has a first port 134, a second port 136, a third port 138, and a fourth port 140. The electrode plate 104 has a first port 142, a second port 144, a third port 146, and a fourth port 148. The separator plate 112 has a first port 150, a second port 152, a third port 154, and a fourth port 156.

The electrode plate 106 has a first port 158, a second port 160, a third port 162, and a fourth port 164. The separator plate 114 has a first port 166, a second port 168, a third port 170, and a fourth port 172. The electrode plate 108 has a first port 174, a second port 176, a third port 178, and a fourth port 180. The separator plate 116 has a first port 182, a second port 184, a third port 186, and a fourth port 188. The configuration and number of ports can be changed based on the application.

The respective ports of the electrode plates 102-108 and the separator plates 110-116 are aligned in a transversal direction (e.g., depth-wise) when the cell stack assembly 100 is formed such that respective channels are formed by the respective ports. Particularly, referring to FIGS. 1-2 together, the ports 126, 134, 142, 150, 158, 166, 174, and 182 form a first channel 190. Similarly, the ports 128, 136, 144, 152, 160, 168, 176, and 184 form a second channel 192. Also, the ports 130, 138, 146, 154, 162, 170, 178, and 186 form a third channel 194. Further, the ports 132, 140, 148, 156, 164, 172, 180, and 188 form a fourth channel 196. The channels 190-196 traverse the electrode plates 102-108 and the separator plates 110-116 to form a continuous duct through which electrolytes and elements can flow.

The electrode plates 102-108 and the separator plates 110-116 are configured to be assembled or stacked in only one orientation in a “poka-yoke” or mistake-proof manner. Particularly, each of the electrode plates 102-108 and the separator plates 110-116 have respective assembly features that match corresponding assembly features of mating (e.g., adjacent or neighboring) plates in only one orientation and order. This way, wrong assembly of the cell stack assembly 100 can be prevented.

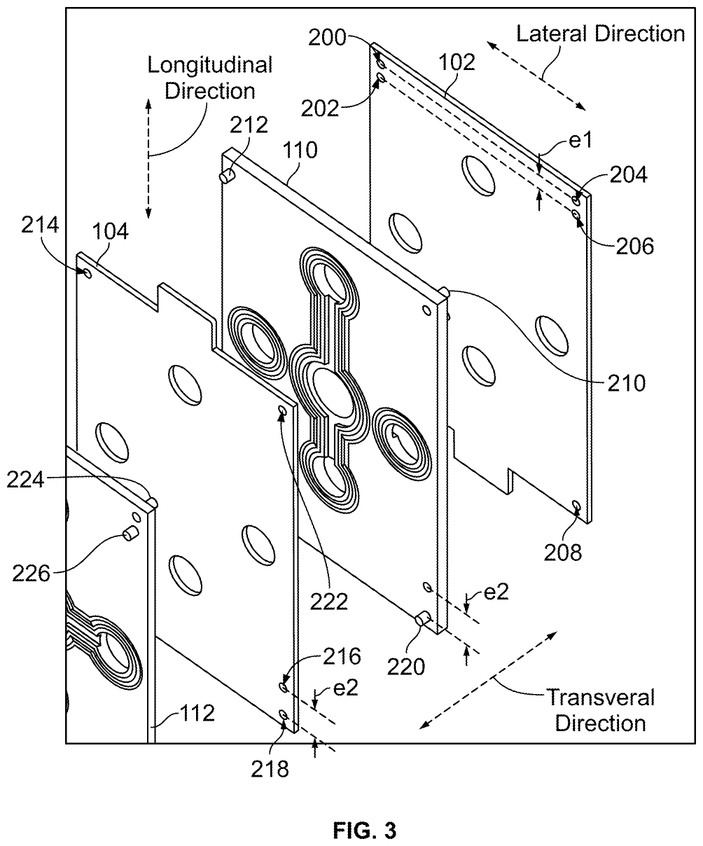

FIG. 3 illustrates a partial exploded view of the cell stack assembly 100, according to an example implementation. Particularly, FIG. 3 illustrates the electrode plates 102, 104, the separator plate 110, and a portion of the separator plate 112.

As depicted, the electrode plate 102 has a plurality of through-holes formed therein. The through-holes can, for example, be formed at corners of the electrode plates in a particular pattern. Particularly, the electrode plate 102 can have a first hole 200 and a second hole 202, both formed at a top left corner of the electrode plate 102 and are aligned longitudinally. The electrode plate 102 also has a third hole 204 and a fourth hole 206, both formed at a top right corner of the electrode plate 102 and are aligned longitudinally. The holes 204, 206 are disposed laterally opposite from the holes 200, 202.

As shown, the holes are offset from each other. Particularly, the first hole 200 and the third hole 204 can be aligned laterally, but they are both shifted longitudinally by an offset “e1” from the second hole 202 and the fourth hole 206.

The electrode plate 102 further includes a fifth hole 208 that is aligned longitudinally with the holes 204, 206 as shown in FIG. 3. The electrode plate 102 may also include a sixth hole laterally opposite from the fifth hole 208 (blocked in the view of FIG. 3 by the separator plate 110).

The separator plate 110 has corresponding features that facilitate locating the separator plate 110 relative to the electrode plate 102 and the electrode plate 104, and mounting the separator plate 110 to the electrode plates 102, 104. Particularly, the separator plate 110 can have a first locating pin 210 that protrudes in a first transversal direction toward the electrode plate 102. The first locating pin 210 can be inserted into the third hole 204, for example.

The separator plate 110 can also have a second locating pin 212 that protrudes in a second transversal direction (opposite the first transversal direction) toward the electrode plate 104 to be inserted into a first hole 214 of the electrode plate 104. The electrode plate 104 also has a second hole 216 and a third hole 218 at an opposite corner of the electrode plate 104 relative to the first hole 214 thereof. The second hole 216 and the third hole 218 are shifted longitudinally from each other by offset “e2” that may be different from the offset “e1.” The separator plate 110 further includes a third locating pin 220 that protrudes in the second transversal direction, similar to the second locating pin 212, to be inserted into the third hole 218 of the electrode plate 104.

Further, the electrode plate 104 has a fourth hole 222 aligned laterally with the first hole 214 and aligned longitudinally with the holes 216, 218. The separator plate 112 has a first locating pin 224 that is aligned transversally with the fourth hole 222 to be inserted therein. The separator plate 112 further includes a second locating pin 226 that is offset longitudinally from the first locating pin 224, and the second locating pin 226 is configured to be inserted into a respective hole of the electrode plate 106 (see FIG. 2).

With this configuration, the electrode plates 102, 104 can be mounted to the separator plate 110 in only one orientation. Similarly, the electrode plate 104 and the electrode plate 106 can be mounted to the separator plate 112 in only one orientation. Further, the electrode plates 102, 104 and the separator plates 110, 112 can be mounted to each other in a unique order.

As such, the electrode plates 102-108 and the separator plates 110-116 mating therewith can have features (e.g., holes, locating pins, the holes and locating pins being offset in a given direction, etc.) that facilitate stacking the electrode plates 102-108 and the separator plates 110-116 in a particular/unique order and orientation that prevents mistaken assembly of the cell stack assembly 100. Particularly, by designating the number and positions of locating pins and holes on the respective electrode plates and the respective separator plates within the cell stack assembly 100, the electrode plates 102-108 and the separator plates 110-116 can be mounted in a unique order and orientation of installation.

The separator plates 110-116 further includes grooves, channels, and seals that facilitate electrolyte flow, without the need for additional ducting in the cell stack assembly 100. Particularly, the separator plates 110-116 have grooves disposed about perimeters of channels formed therein, and elastomer seals are disposed in the grooves to bound and seal the channels. Thus, effective flow channels with sealed perimeters are formed in the separator plates 110-116, eliminating the need for additional plumbing (additional ducts and components to seal and guide the fluid flow).

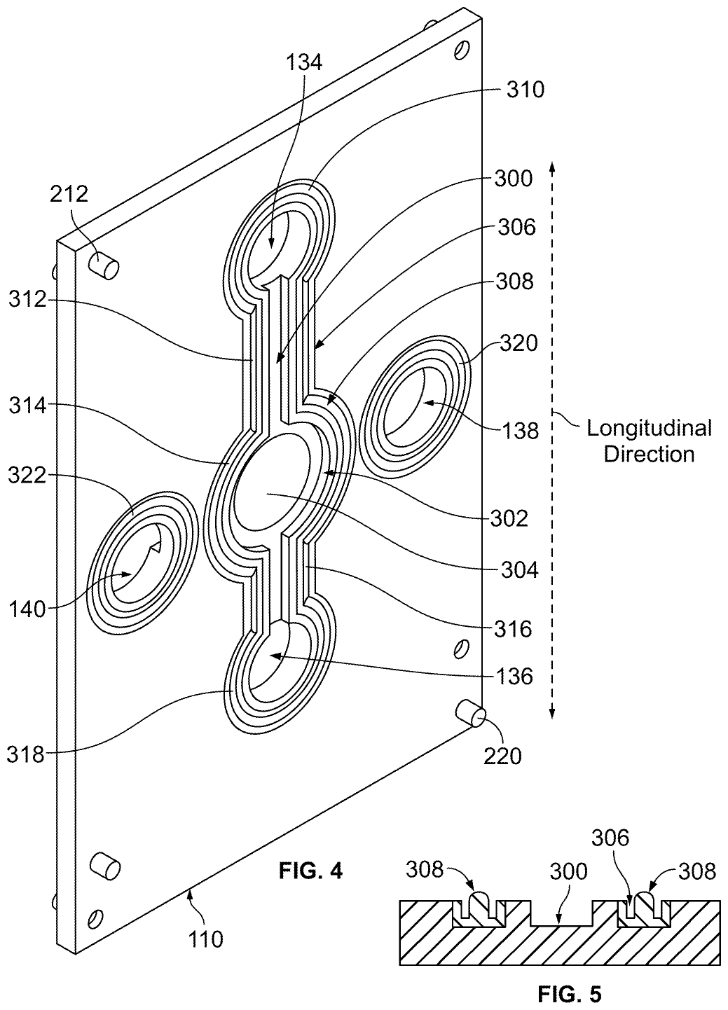

FIG. 4 illustrates a perspective view of the separator plate 110 depicting a front side thereof, according to an example implementation. As depicted, the separator plate 110 has a first electrolyte flow channel 300 on the front side. The first electrolyte flow channel 300 can be a longitudinal channel (oriented or disposed in a longitudinal direction), for example.

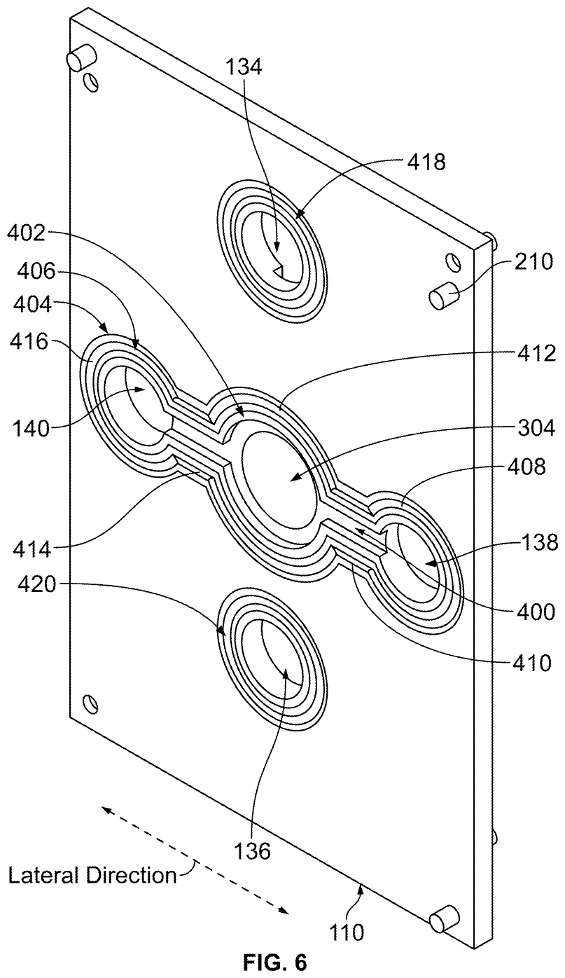

As shown, the first electrolyte flow channel 300 connects or fluidly couples the first port 134 to the second port 136 of the separator plate 110. Further, the first electrolyte flow channel 300 has an enlarged center portion 302 that accommodates a separator membrane 304. In an example, the separator membrane 304 is made of a material that extracts at least one element from the electrolyte flowing through the first electrolyte flow channel 300 when electric power is applied to the electrode plates that interface with the separator plate 110. The extracted element then permeates through the separator membrane 304 to the back side of the separator plate 110 shown in FIG. 6.

The separator plate 110 further has a groove 306 that bounds or defines the first electrolyte flow channel 300. Particularly, the groove 306 bounds the first port 134, the first electrolyte flow channel 300, and the second port 136. The separator plate 110 also has a seal 308 disposed in the groove 306 to seal the first port 134, the first electrolyte flow channel 300, and the second port 136. In an example, the seal 308 (e.g., an elastomeric seal) is molded (e.g., elastomer over-molding) into the groove 306.

The shape of the seal 308 facilitates mounting it into the groove 306. For example, the seal 308 has a first circular end portion 310 disposed about the first port 134, a first longitudinal portion 312, a central circular portion 314 that bounds the enlarged center portion 302 of the first electrolyte flow channel 300, a second longitudinal portion 316, and a second circular end portion 318 disposed about the second port 136.

FIG. 5 illustrates a cross sectional view of the separator plate 110, according to an example implementation. The cutting plane of the cross section depicted in FIG. 5 passes through the first longitudinal portion 312 of the seal 308, and depicts the cross-sectional shape of the seal 308.

Referring to FIG. 4, the separator plate 110 further includes another groove in which a seal 320 is disposed to seal the third port 138. The separator plate also includes another groove in which a seal 322 is disposed to seal the fourth port 140.

FIG. 6 illustrates another perspective view of the separator plate 110 depicting a back side thereof, according to an example implementation. As depicted in FIG. 6, the back side of the separator plate 110 has a second electrolyte flow channel 400. The second electrolyte flow channel 400 can be a lateral channel (e.g., disposed in a lateral direction), for example. As such, in the example implementation of FIGS. 4, 6, the second electrolyte flow channel 400 is perpendicular to the first electrolyte flow channel 300. However, in other example implementations, the second electrolyte flow channel 400 might not be perpendicular to the first electrolyte flow channel 300 depending on the pattern and locations of the ports of the separator plate 110. For the example, the electrolyte flow channels 300, 400 can crisscross to form an X-shape.

As shown in FIG. 6, the second electrolyte flow channel 400 connects or fluidly couples the third port 138 to the fourth port 140 of the separator plate 110. Further, the second electrolyte flow channel 400 has an enlarged center portion 402 that accommodates the separator membrane 304. The separator membrane 304 is exposed to both the first electrolyte flow channel 300 and the second electrolyte flow channel 400.

The back side of the separator plate 110 has a groove 404 that bounds or defines the second electrolyte flow channel 400. Particularly, the groove 404 bounds the third port 138, the second electrolyte flow channel 400, and the fourth port 140. The separator plate 110 also has a seal 406 disposed in the groove 404 to seal the third port 138, the second electrolyte flow channel 400, and the fourth port 140. In an example, the seal 406 (e.g., an elastomeric seal) is molded (e.g., elastomer over-molding) into the groove 404.

The shape of the seal 406 facilitates mounting it into the groove 404. For example, the seal 406 has a first circular end portion 408 disposed about the third port 138, a first longitudinal portion 410, a central circular portion 412 that bounds the enlarged center portion 402 of the second electrolyte flow channel 400, a second longitudinal portion 414, and a second circular end portion 416 disposed about the fourth port 140.

The back side of the separator plate 110 further includes another groove in which a seal 418 is disposed to seal the first port 134. The separator plate also includes another groove in which a seal 420 is disposed to seal the second port 136.

The other separator plates 112, 114, and 116 can be configured similar to the separator plate 110. However, as best illustrated in FIG. 2, consecutive separator plates can be mirror images of, or flipped with respect to, each other. For example, the back side of the separator plate 112 can be configured to be similar to the front side of the separator plate 110, and so on.

Operation of the cell stack assembly 100 can be described with respect to FIGS. 1-2 and 4-5. An electrolyte can be provided from a source of electrolyte to the second port 128 of the electrode plate 102 to flow through the second channel 192 (see FIG. 1). The electrolyte can thus flow through the second port 128 of the electrode plate 102 then through the second port 136 of the separator plate 110. A portion of the electrolyte can then flow through the first electrolyte flow channel 300 to the first port 134 of the separator plate 110.

As the portion of the electrolyte flows through the first electrolyte flow channel 300, the electrolyte is exposed to the separator membrane 304. Due to the electric power provided to the electrode plates 102, 104 and the material of the separator membrane 304, the separator membrane 304 extracts at least one element of the electrolyte and allows the extracted element to permeate or diffuse through the separator membrane 304 to the back side of the separator plate 110, particularly to the second electrolyte flow channel 400. The extracted element of the electrolyte can then flow to the third port 138 and the fourth port 140 to be recovered through the channels 194, 196 (see FIG. 1).

The other portion of the electrolyte can continue to flow through the second channel 192, where the process that takes place at the separator plate 110 is repeated sequentially at the following separator plates 112, 114, 116. At the end of the cell stack assembly 100, the excess electrolyte that has not been separated into elements may flow through a respective first electrolyte flow channel of a respective separator plate at the end of the cell stack assembly 100, then returns through the first channel 190. Such excess electrolyte can then be recirculated through the cell stack assembly 100.

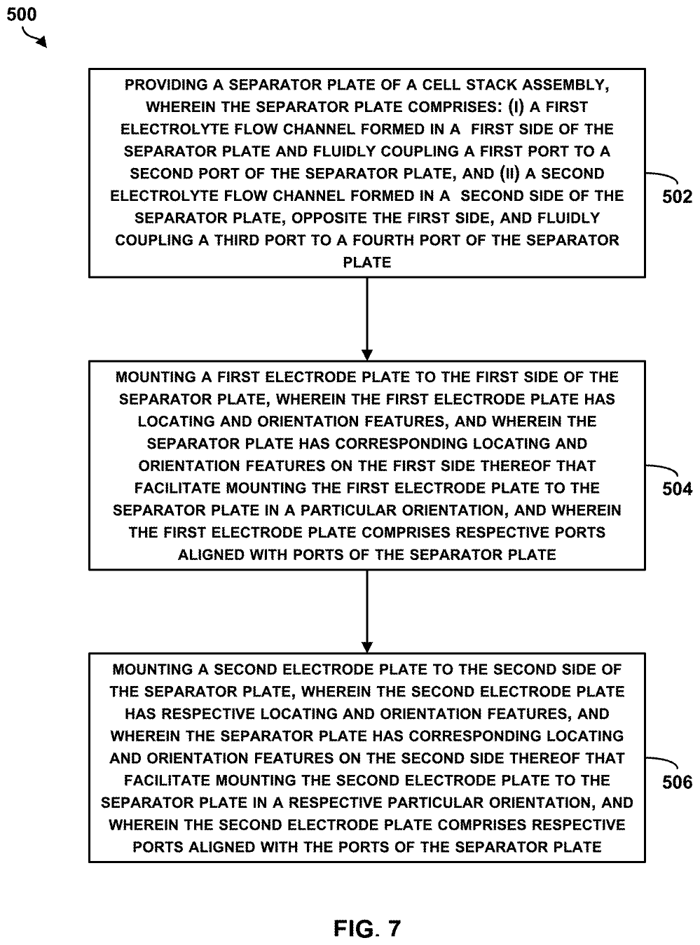

FIG. 7 is a flowchart of a method 500 of assembling a cell stack assembly, according to an example implementation. The method 500 can be used to form at least a portion of the cell stack assembly 100, for example.

The method 500 may include one or more operations, functions, or actions as illustrated by one or more of blocks 502-506 and 600-602. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 502, the method 500 includes providing the separator plate 110 of the cell stack assembly 100, wherein the separator plate 110 comprises: (i) the first electrolyte flow channel 300 formed in a first side of the separator plate 110 and fluidly coupling the first port 134 to the second port 136 of the separator plate 110, and (ii) the second electrolyte flow channel 400 formed in a second side of the separator plate 110, opposite the first side, and fluidly coupling the third port 138 to the fourth port 140 of the separator plate 110. The term “providing” as used herein, and for example with regard to the separator plate 110 or other components, includes any action to make the separator plate 110 or any other component available for use, such as bringing the separator plate 110 to an apparatus or to a work environment for further processing (e.g., mounting other components, molding the elastomeric sealing elements, etc.).

At block 504, the method 500 includes mounting the first electrode plate 102 to the first side of the separator plate 110, wherein the first electrode plate 102 has locating and orientation features (e.g., the holes 200, 202, 204, 206, 208), and wherein the separator plate 110 has corresponding locating and orientation features (e.g., the locating pin 210) on the first side thereof that facilitate mounting the first electrode plate 102 to the separator plate 110 in a particular orientation, and wherein the first electrode plate 102 comprises respective ports (the ports 126, 128, 130, 132) aligned with ports (the ports 134, 136, 138, 140) of the separator plate 110.

At block 506, the method 500 includes mounting the second electrode plate 104 to the second side of the separator plate 110, wherein the second electrode plate 104 has respective locating and orientation features (e.g., the holes 214, 216, 218, 222), and wherein the separator plate 110 has corresponding locating and orientation features (e.g., the locating pins 212, 220) on the second side thereof that facilitate mounting the second electrode plate 104 to the separator plate 110 in a respective particular orientation, and wherein the second electrode plate 104 comprises respective ports (e.g., the ports 142, 144, 146, 148) aligned with the ports 134, 136, 138, 140 of the separator plate 110.

As described above, the corresponding locating and orientation features on the first side of the separator plate 110 can include one or more locating pins such as the locating pin 210 protruding in a first transversal direction and inserted into respective holes such as the hole 204 in the first electrode plate 102, and wherein the corresponding locating and orientation features on the second side of the separator plate 110 can include one or more respective locating pins (e.g., the locating pins 212, 220) protruding in a second transversal direction, opposite the first transversal direction, and inserted into respective holes (e.g., the holes 214, 218) in the second electrode plate 104.

The method 500 can further include any of the other steps or operations described throughout herein.

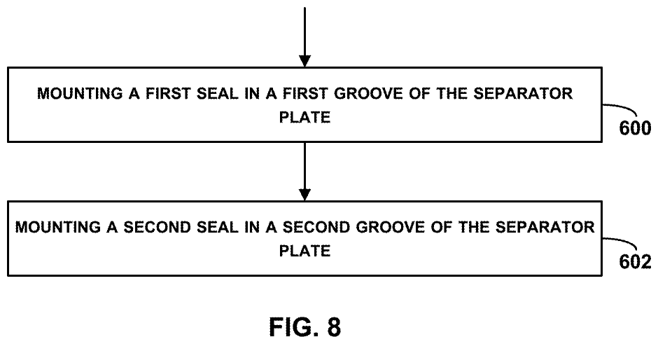

FIG. 8 is a flowchart of additional operations performed with the method 500 of FIG. 7, according to an example implementation. As described above, the separator plate 110 can include (i) the groove 306 on the first side, wherein the groove 306 bounds the first electrolyte flow channel 300, and (ii) the groove 404 on the second side, wherein the groove 404 bounds the second electrolyte flow channel 400. At block 600, operations include mounting the seal 308 in the groove 306, and at block 602, operations include mounting the seal 406 in the groove 404.

The method can further include mounting other electrode and separator plates of the cell stack assembly 100 in a similar manner.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a cell stack assembly comprising: a plurality of electrode plates having: (i) respective terminal tabs integrated therewith for providing electric power to the plurality of electrode plates, (ii) and respective ports; and a plurality of separator plates interleaved with the plurality of electrode plates and having respective ports aligned with the respective ports of the plurality of electrode plates to form channels that allow electrolyte flow therethrough, wherein the plurality of electrode plates have locating and orientation features, and wherein the plurality of separator plates have corresponding locating and orientation features that facilitate mounting the plurality of electrode plates to the plurality of separator plates in a unique order and orientation.

EEE 2 is the cell stack assembly of EEE 1, wherein a first subset of the plurality of electrode plates are cathode plates, wherein a second subset of the plurality of electrode plates are anode plates, wherein respective terminal tabs of the cathode plates protrude in a first direction, and wherein respective terminal tabs of the anode plates protrude in a second direction, different from the first direction.

EEE 3 is the cell stack assembly of EEE 2, wherein the respective terminal tabs of the cathode plates protrude in a first longitudinal direction, and wherein respective terminal tabs of the anode plates protrude in a second longitudinal direction.

EEE 4 is the cell stack assembly of any of EEEs 1-3, wherein an electrode plate of the plurality of electrode plates has a first port, a second port, a third port, and a fourth port, and wherein a separator plate of the plurality of separator plates interfacing with the electrode plate has a respective first port aligned with the first port of the electrode plate, a respective second port aligned with the second port of the electrode plate, a respective third port aligned with the third port of the electrode plate, and a respective fourth port aligned with the fourth port of the electrode plate.

EEE 5 is the cell stack assembly of any of EEEs 1-4, wherein a separator plate of the plurality of separator plates comprises a first electrolyte flow channel formed in a first side of the separator plate and a second electrolyte flow channel formed in a second side of the separator plate, opposite the first side.

EEE 6 is the cell stack assembly of EEE 5, wherein the first electrolyte flow channel is a longitudinal channel, and wherein the second electrolyte flow channel is a lateral channel.

EEE 7 is the cell stack assembly of any of EEEs 5-6, wherein the first electrolyte flow channel fluidly couples a first port of the separator plate to a second port of the separator plate, and wherein the second electrolyte flow channel fluidly couples a third port of the separator plate to a fourth port of the separator plate.

EEE 8 is the cell stack assembly of any of EEEs 5-7, wherein the separator plate comprises: a separator membrane configured to extract an element from an electrolyte flowing through the first electrolyte flow channel, wherein the separator membrane allow the element to diffuse to the second electrolyte flow channel.

EEE 9 is the cell stack assembly of EEE 8, wherein the first electrolyte flow channel has an enlarged center portion that accommodates the separator membrane, and wherein the second electrolyte flow channel has a respective enlarged center portion that accommodates the separator membrane.

EEE 10 is the cell stack assembly of EEE 9, wherein the separator plate comprises: a groove formed in the first side of the separator plate and bounds the first electrolyte flow channel; and a seal mounted into the groove.

EEE 11 is the cell stack assembly of EEE 10, wherein the seal comprises: a first circular end portion disposed about a first port of the separator plate; a first longitudinal portion; a central circular portion that bounds the enlarged center portion of the first electrolyte flow channel; a second longitudinal portion; and a second circular end portion disposed about a second port of the separator plate.

EEE 12 is the cell stack assembly of EEE 11, wherein the seal is a first seal, and wherein the separator plate further comprises: a second seal disposed about a third port of the separator plate; and a third seal disposed about a fourth port of the separator plate.

EEE 13 is the cell stack assembly of any of EEEs 10-12, wherein the groove is a first groove and the seal is a first seal, and wherein the separator plate further comprises: a second groove formed in the second side of the separator plate and bounds the second electrolyte flow channel; and a second seal mounted into the second groove.

EEE 14 is the cell stack assembly of EEE 13, wherein the second seal comprises: a first circular end portion disposed about a third port of the separator plate; a first longitudinal portion; a central circular portion that bounds the enlarged center portion of the second electrolyte flow channel; a second longitudinal portion; and a second circular end portion disposed about a fourth port of the separator plate.

EEE 15 is the cell stack assembly of EEE 14, wherein the separator plate further comprises: a third seal disposed in the second side about a first port of the separator plate; and a fourth seal disposed in the second side about a second port of the separator plate.

EEE 16 is the cell stack assembly of any of EEEs 1-15, wherein the locating and orientation features of the plurality of electrode plates and the corresponding locating and orientation features of the plurality of separator plates comprise locating pins configured to be inserted into respective holes in a particular orientation.

EEE 17 is the cell stack assembly of EEE 16, wherein the locating pins or the respective holes of a separator plate or an electrode plate are offset from each other to facilitate mounting the separator plate to the electrode plate in the unique order and orientation

EEE 18 is a method of assembling at least a portion of the cell stack assembly of any of EEEs 1-17. For example, the method includes: providing a separator plate of a cell stack assembly, wherein the separator plate comprises: (i) a first electrolyte flow channel formed in a first side of the separator plate and fluidly coupling a first port to a second port of the separator plate, and (ii) a second electrolyte flow channel formed in a second side of the separator plate, opposite the first side, and fluidly coupling a third port to a fourth port of the separator plate; mounting a first electrode plate to the first side of the separator plate, wherein the first electrode plate has locating and orientation features, and wherein the separator plate has corresponding locating and orientation features on the first side thereof that facilitate mounting the first electrode plate to the separator plate in a particular orientation, and wherein the first electrode plate comprises respective ports aligned with ports of the separator plate; and mounting a second electrode plate to the second side of the separator plate, wherein the second electrode plate has respective locating and orientation features, and wherein the separator plate has corresponding locating and orientation features on the second side thereof that facilitate mounting the second electrode plate to the separator plate in a respective particular orientation, and wherein the second electrode plate comprises respective ports aligned with the ports of the separator plate.

EEE 19 is the method of EEE 18, wherein the corresponding locating and orientation features on the first side of the separator plate comprise one or more locating pins protruding in a first transversal direction and inserted into respective holes in the first electrode plate, and wherein the corresponding locating and orientation features on the second side of the separator plate comprise one or more respective locating pins protruding in a second transversal direction, opposite the first transversal direction, and inserted into respective holes in the second electrode plate.

EEE 20 is the method of any of EEEs 18-19, wherein the separator plate comprises (i) a first groove on the first side, wherein the first groove bounds the first electrolyte flow channel, and (ii) a second groove on the second side, wherein the second groove bounds the second electrolyte flow channel, wherein the method further comprises: mounting a first seal in the first groove; and mounting a second seal in the second groove.

What is claimed is:

1. A cell stack assembly comprising:
a plurality of electrode plates having: (i) respective terminal tabs integrated therewith for providing electric power to the plurality of electrode plates, (ii) and respective ports; and
a plurality of separator plates interleaved with the plurality of electrode plates and having respective ports aligned with the respective ports of the plurality of electrode plates to form channels that allow electrolyte flow therethrough, wherein the plurality of electrode plates have locating and orientation features, and wherein the plurality of separator plates have corresponding locating and orientation features that facilitate mounting the plurality of electrode plates to the plurality of separator plates in a unique order and orientation.

2. The cell stack assembly of claim 1, wherein a first subset of the plurality of electrode plates are cathode plates, wherein a second subset of the plurality of electrode plates are anode plates, wherein respective terminal tabs of the cathode plates protrude in a first direction, and wherein respective terminal tabs of the anode plates protrude in a second direction, different from the first direction.

3. The cell stack assembly of claim 2, wherein the respective terminal tabs of the cathode plates protrude in a first longitudinal direction, and wherein respective terminal tabs of the anode plates protrude in a second longitudinal direction.

4. The cell stack assembly of claim 1, wherein an electrode plate of the plurality of electrode plates has a first port, a second port, a third port, and a fourth port, and wherein a separator plate of the plurality of separator plates interfacing with the electrode plate has a respective first port aligned with the first port of the electrode plate, a respective second port aligned with the second port of the electrode plate, a respective third port aligned with the third port of the electrode plate, and a respective fourth port aligned with the fourth port of the electrode plate.

5. The cell stack assembly of claim 1, wherein a separator plate of the plurality of separator plates comprises a first electrolyte flow channel formed in a first side of the separator plate and a second electrolyte flow channel formed in a second side of the separator plate, opposite the first side.

6. The cell stack assembly of claim 5, wherein the first electrolyte flow channel is a longitudinal channel, and wherein the second electrolyte flow channel is a lateral channel.

7. The cell stack assembly of claim 5, wherein the first electrolyte flow channel fluidly couples a first port of the separator plate to a second port of the separator plate, and wherein the second electrolyte flow channel fluidly couples a third port of the separator plate to a fourth port of the separator plate.

8. The cell stack assembly of claim 5, wherein the separator plate comprises:
a separator membrane configured to extract an element from an electrolyte flowing through the first electrolyte flow channel, wherein the separator membrane allow the element to diffuse to the second electrolyte flow channel.

9. The cell stack assembly of claim 8, wherein the first electrolyte flow channel has an enlarged center portion that accommodates the separator membrane, and wherein the second electrolyte flow channel has a respective enlarged center portion that accommodates the separator membrane.

10. The cell stack assembly of claim 9, wherein the separator plate comprises:
a groove formed in the first side of the separator plate and bounds the first electrolyte flow channel; and
a seal mounted into the groove.

11. The cell stack assembly of claim 10, wherein the seal comprises:
a first circular end portion disposed about a first port of the separator plate;
a first longitudinal portion;
a central circular portion that bounds the enlarged center portion of the first electrolyte flow channel;
a second longitudinal portion; and
a second circular end portion disposed about a second port of the separator plate.

12. The cell stack assembly of claim 11, wherein the seal is a first seal, and wherein the separator plate further comprises:
a second seal disposed about a third port of the separator plate; and
a third seal disposed about a fourth port of the separator plate.

13. The cell stack assembly of claim 10, wherein the groove is a first groove and the seal is a first seal, and wherein the separator plate further comprises:
a second groove formed in the second side of the separator plate and bounds the second electrolyte flow channel; and
a second seal mounted into the second groove.

14. The cell stack assembly of claim 13, wherein the second seal comprises:
a first circular end portion disposed about a third port of the separator plate;
a first longitudinal portion;
a central circular portion that bounds the enlarged center portion of the second electrolyte flow channel;
a second longitudinal portion; and
a second circular end portion disposed about a fourth port of the separator plate.

15. The cell stack assembly of claim 14, wherein the separator plate further comprises:
a third seal disposed in the second side about a first port of the separator plate; and
a fourth seal disposed in the second side about a second port of the separator plate.

16. The cell stack assembly of claim 1, wherein the locating and orientation features of the plurality of electrode plates and the corresponding locating and orientation features of the plurality of separator plates comprise locating pins configured to be inserted into respective holes in a particular orientation.

17. The cell stack assembly of claim 16, wherein the locating pins or the respective holes of a separator plate or an electrode plate are offset from each other to facilitate mounting the separator plate to the electrode plate in the unique order and orientation.

18. A method comprising:
providing a separator plate of a cell stack assembly, wherein the separator plate comprises: (i) a first electrolyte flow channel formed in a first side of the separator plate and fluidly coupling a first port to a second port of the separator plate, and (ii) a second electrolyte flow channel formed in a second side of the separator plate, opposite the first side, and fluidly coupling a third port to a fourth port of the separator plate;
mounting a first electrode plate to the first side of the separator plate, wherein the first electrode plate has locating and orientation features, and wherein the separator plate has corresponding locating and orientation features on the first side thereof that facilitate mounting the first electrode plate to the separator plate in a particular orientation, and wherein the first electrode plate comprises respective ports aligned with ports of the separator plate; and
mounting a second electrode plate to the second side of the separator plate, wherein the second electrode plate has respective locating and orientation features, and wherein the separator plate has corresponding locating and orientation features on the second side thereof that facilitate mounting the second electrode plate to the separator plate in a respective particular orientation, and wherein the second electrode plate comprises respective ports aligned with the ports of the separator plate.

19. The method of claim 18, wherein the corresponding locating and orientation features on the first side of the separator plate comprise one or more locating pins protruding in a first transversal direction and inserted into respective holes in the first electrode plate, and wherein the corresponding locating and orientation features on the second side of the separator plate comprise one or more respective locating pins protruding in a second transversal direction, opposite the first transversal direction, and inserted into respective holes in the second electrode plate.

20. The method of claim 18, wherein the separator plate comprises (i) a first groove on the first side, wherein the first groove bounds the first electrolyte flow channel, and (ii) a second groove on the second side, wherein the second groove bounds the second electrolyte flow channel, wherein the method further comprises:
mounting a first seal in the first groove; and
mounting a second seal in the second groove.
